(19) United States
(12) Patent Application Publication
(10) Pub. No.: US 2016/0028106 A1
(43) Pub. Date: Jan. 28, 2016

(54) SULFIDE SOLID ELECTROLYTE MATERIAL, BATTERY, AND METHOD FOR PRODUCING SULFIDE SOLID ELECTROLYTE MATERIAL

(71) Applicant: TOYOTA JIDOSHA KABUSHIKI KAISHA, Toyota-shi (JP)

(72) Inventor: Yuki KATO, Gotenba-shi (JP)

(21) Appl. No.: 14/797,723

(22) Filed: Jul. 13, 2015

(30) Foreign Application Priority Data
Jul. 22, 2014 (JP) 2014-148633

(51) Int. Cl. H01M 10/0562; H01M 10/0525

(52) U.S. Cl. CPC H01M 10/0562; H01M 10/0525; H01M 2300/0068

(57) ABSTRACT

An object of the present invention is to provide a sulfide solid electrolyte material having satisfactory ion conductivity. The present invention attains the object by providing a sulfide solid electrolyte material comprising a Li element, a Ge element, a P element, a S element, and an X element (X is at least one of F, Cl, Br and I), wherein the sulfide solid electrolyte material comprises a crystal phase A having a peak at the position of 2θ=29.58°±1.00° measured by X-ray diffractometry using CuKα ray, has a composition of y(LiX)·(100−y) (Li_{3.35}Ge_{0.35}P_{0.65}S₄) (y satisfies the relationship: 0<y<20), and the sulfide solid electrolyte material does not comprise a crystal phase B having a peak at the position of 2θ=25.20°±1.00° measured by X-ray diffractometry using CuKα ray.

### TECHNICAL FIELD

The present invention relates to a sulfide solid electrolyte material having satisfactory ion conductivity.

### BACKGROUND ART

Along with the rapid distribution of information-related equipment and communication equipment such as personal computers, video cameras, and mobile telephones in recent years, the development of batteries that are utilized as electric power sources thereof has been considered important. Furthermore, the development of high output power and high capacity batteries for electric vehicles or hybrid vehicles is in progress in the field of automobile industry and the like as well. Currently, among various batteries, lithium batteries are attracting attention because of its high energy densities.

In regard to the lithium batteries that are currently available in the market, since liquid electrolytes including flammable organic solvents are used, installation of safety devices that suppress temperature increase at the time of short circuits, and devices for preventing short circuits are needed. Meanwhile, since lithium batteries that have been produced into all solid state batteries by converting the liquid electrolyte to a solid electrolyte layer do not use flammable organic solvents in the batteries, it is contemplated that simplification of safety devices can be promoted, and the lithium batteries are excellent in view of the production cost and productivity.

Regarding the solid electrolyte materials used in all solid lithium batteries, sulfide solid electrolyte materials are known. For example, Patent Literature 1 discloses a sulfide solid electrolyte material having a composition of Li₍₄₋ₓ₎Ge₍₁₋ₓ₎PₓS₄. Also, for example, Non-Patent Literature 1 discloses a glass ceramic having a composition of (100−x)(0.7Li₂S.0.3P₂S₅).xLiBr (x=0.5, 10, 12.5, 15, 20).

### CITATION LIST

### Patent Literature

Patent Literature 1: WO 2011/118801

### Non Patent Literature

Non-Patent Literature 1: Satoshi Ujiie, et al., “Preparation and electrochemical characterization of (100−x)(0.7Li2S.0.3P2S5).xLiBr glass-ceramic electrolytes”, Mater Renew Sustain Energy (2014) 3:18

### SUMMARY OF INVENTION

### Technical Problem

From the viewpoint of increasing the output power of batteries, there is a demand for a solid electrolyte material having satisfactory ion conductivity. The present invention was achieved in view of the problem described above, and it is a main object of the present invention to provide a sulfide solid electrolyte material having satisfactory ion conductivity.

### Solution to Problem

In order to solve the problem described above, according to an aspect of the present invention, there is provided a sulfide solid electrolyte material comprising a Li element, a Ge element, a P element, a S element, and an X element (X is at least one of F, Cl, Br, and I), wherein the sulfide solid electrolyte material comprising a crystal phase A having a peak at a position of 2θ=29.58°±1.00° in an X-ray diffractometry using CuKα ray, having a composition of y(LiX)·(100−y) (Li_{3.35}Ge_{0.35}P_{0.65}S₄) (y satisfies the relationship: 0<y<20), and the sulfide solid electrolyte material does not comprise a crystal phase B that has a peak at a position of 2θ=25.20°±1.00° measured by X-ray diffractometry using CuKα ray.

According to the present invention, since the sulfide solid electrolyte material comprises the crystal phase A containing the X element, a sulfide solid electrolyte material having satisfactory ion conductivity can be obtained as compared with the case of solid electrolyte materials that do not contain the X element. Furthermore, since the sulfide solid electrolyte material of the present invention does not comprise the crystal phase B, ion conductivity can be maintained at a high level.

According to the invention described above, it is preferable that X is Br.

Furthermore, according to another aspect of the present invention, there is provided a battery comprising a cathode active material layer containing a cathode active material; an anode active material layer containing an anode active material; and an electrolyte layer formed between the cathode active material layer and the anode active material layer, wherein at least one of the cathode active material layer, the anode active material layer, and the electrolyte layer contains the sulfide solid electrolyte material described above.

According to the present invention, a high output power battery can be obtained by using the sulfide solid electrolyte material described above.

Furthermore, according to another aspect of the present invention, there is provided a method for producing the sulfide solid electrolyte material, the sulfide solid electrolyte material being the sulfide solid electrolyte material described above, the method comprising steps of: an ion conductive material synthesis step of synthesizing an amorphized ion conductive material by mechanical milling, using a raw material composition containing a constituent component of the sulfide solid electrolyte material; and a heating step of heating the amorphized ion conductive material, and thereby obtaining the sulfide solid electrolyte material.

According to the present invention, a sulfide solid electrolyte material having satisfactory ion conductivity can be obtained by performing amorphization in the ion conductive material synthesis step, and then performing the heating step.

### Advantageous Effects of Invention

The sulfide solid electrolyte material of the present invention provides an effect of obtaining satisfactory ion conductivity.

### BRIEF DESCRIPTION OF DRAWINGS

FIG. 1 is a perspective view describing an example of the crystal structure of a crystal phase A according to the present invention;

FIG. 2 is a schematic sectional view illustrating an example of the battery of the present invention;

FIG. 3 is an explanatory view illustrating an example of the method for producing a sulfide solid electrolyte material of the present invention;

FIG. 4 is a quaternary phase view showing the compositions of the sulfide solid electrolyte materials obtained in Example 1 and Comparative Examples 1 to 3;

FIG. 5 is X-ray diffraction spectra of the sulfide solid electrolyte materials obtained in Example 1 and Comparative Examples 1 to 3; and

FIG. 6 is a graph illustrating the relationship between y which is the amount of addition of LiBr, and the Li ion conductance.

### DESCRIPTION OF EMBODIMENTS

Hereinafter, the sulfide solid electrolyte material, battery, and the method for producing a sulfide solid electrolyte material of the present invention will be described in detail.

A. Sulfide Solid Electrolyte Material

First, the sulfide solid electrolyte material of the present invention is described. The sulfide solid electrolyte material of the present invention comprises a Li element, a Ge element, a P element, a S element, and an X element (X is at least one of F, Cl, Br and I), wherein the sulfide solid electrolyte material comprises a crystal phase A having a peak at a position of 2θ=29.58°±1.00° in an X-ray diffractometry using CuKα ray, has a composition of y(LiX)·(100−y) (Li_{3.35}Ge_{0.35}P_{0.65}S₄) (y satisfies the relationship: 0<y<20), and the sulfide solid electrolyte material does not comprise a crystal phase B having a peak at a position of 2θ=25.20°±1.00° measured by X-ray diffractometry using CuKα ray.

According to the present invention, since the sulfide solid electrolyte material comprises the crystal phase A containing the X element, a sulfide solid electrolyte material having satisfactory ion conductivity can be obtained as compared with the case of solid electrolyte materials that do not contain the X element. Furthermore, since the sulfide solid electrolyte material of the present invention does not comprise the crystal phase B, ion conductivity can be maintained at a high level. Furthermore, according to the present invention, it was found that even if the X element is added at a proportion in a particular range, the crystal structure of the crystal phase A is maintained, and higher ion conductivity is exhibited. Incidentally, the sulfide solid electrolyte material of the present invention is a novel material that is conventionally not known.

The sulfide solid electrolyte material of the present invention comprises a crystal phase A having a peak at the position of 2θ=29.58°±1.00° measured by X-ray diffractometry using CuKα ray. The crystal phase A is the same crystal phase as that of the LiGePS-based sulfide solid electrolyte material described in Patent Literature 1, and has high ion conductivity. The crystal phase A usually has peaks at positions of 2θ=17.38°, 20.18°, 20.44°, 23.56°, 23.96°, 24.93°, 26.96°, 29.07°, 29.58°, 31.71°, 32.66°, and 33.39°.

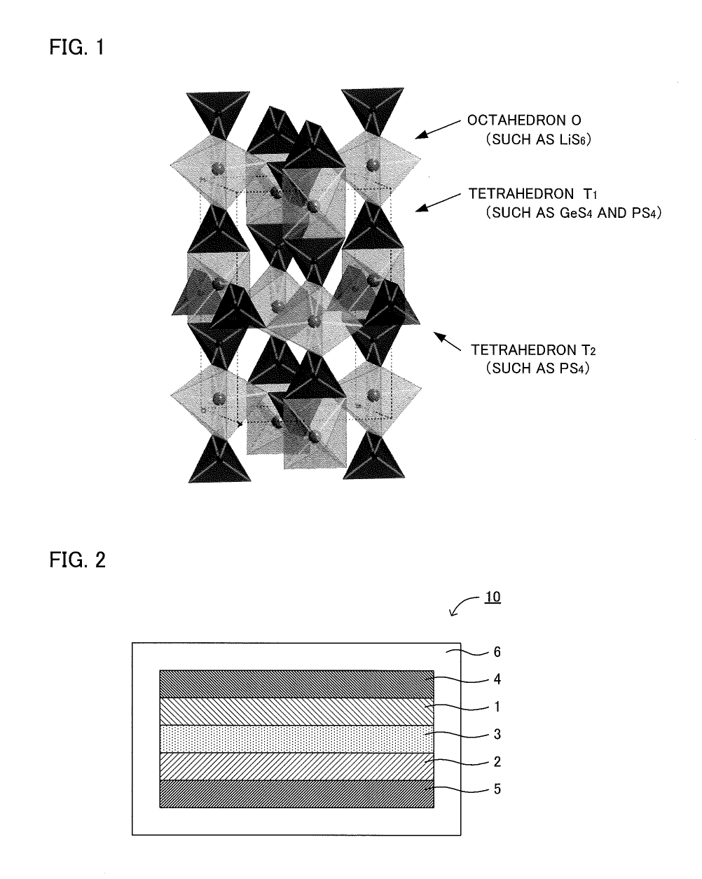

FIG. 1 is a perspective view describing an example of the crystal structure of the crystal phase A. The crystal phase A has a crystal structure which has an octahedron O composed of a Li element and a S element; a tetrahedron T₁ composed of an Mₐ element and a S element; and a tetrahedron T₂ composed of an M_{b} element and a S element, and the tetrahedron T₁ and the octahedron O share edges, while the tetrahedron T₂ and the octahedron O share corners. At least one of the Mₐ element and the M_{b} element includes a Ge element, and at least one of the Mₐ element and the M_{b} element includes a P element.

According to the present invention, the reason why the ion conductivity is increased is speculated as follows. When LiX is added, a LiX₄ tetrahedron is formed at a position of the tetrahedron T₁. Since the ionic radius of Li is larger than the ionic radius of P and Ge, the tetrahedron LiX₄ is larger than the tetrahedron PS₄ and the tetrahedron GeS₄. It is speculated that thereby, the size of the ion conduction pathway becomes larger, and ion conductivity is enhanced. Incidentally, in the tetrahedron LiS₄, since lithium is ionized in this configuration, the tetrahedron LiS₄ cannot function as the tetrahedron T₁ that forms the skeleton. On the other hand, since the X element can suppress the ionization of Li compared with the S element, the tetrahedron LiX₄ is believed to be able to function as the tetrahedron T₁.

The proportion of the crystal phase A with respect to all the crystal phases contained in the sulfide solid electrolyte material of the present invention is not particularly limited; however, the proportion is preferably 50 wt % or more, more preferably 70 wt % or more, and even more preferably 90 wt % or more. Incidentally, the proportion of a crystal phase can be analyzed by, for example, synchrotron radiation XRD.

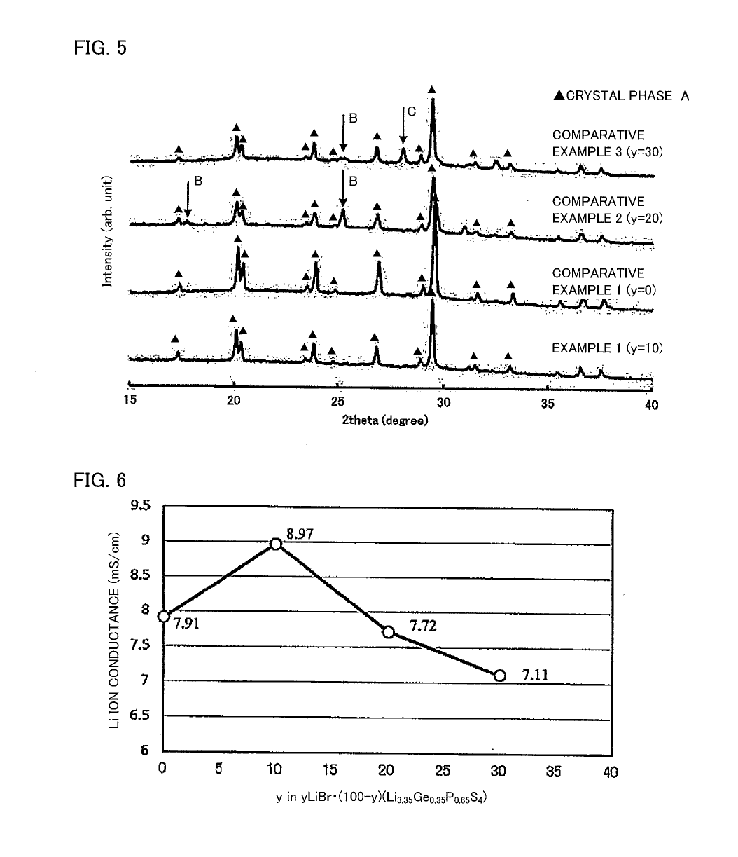

Furthermore, as described in Comparative Example 2 below, if the proportion of LiX is too large in the present invention, a crystal phase different from the crystal phase A is generated. When this crystal phase is designated as a crystal phase B, it usually has a peak of 2θ=25.20°. Also, the peak near 2θ=17° as shown in FIG. 5 that will be described below is speculated to be a peak of the crystal phase B. Incidentally, there are occasions in which this peak position approximates the given value in the range ±1.00°. Among others, it is preferable that a position of each peak approximates the given value in the range of ±0.50°. The crystal phases A and B are crystal phases that both exhibit ion conductivity; however, there is a difference in the ion conductivity, and the crystal phase B is considered to have lower ion conductivity than the crystal phase A. Therefore, it is preferable that the sulfide solid electrolyte material of the present invention does not have the crystal phase B. Incidentally, the phrase “do not have the crystal phase B” as used in the present invention implies that even if no peak is recognized near a position 2θ=25.20° in an XRD analysis, or a very small peak is recognized, a small amount of the crystal phase B exists at a proportion by which higher ion conductivity than that of the sulfide solid electrolyte material with y=0 (Li_{3.35}Ge_{0.35}P_{0.65}S₄) is obtained. Here, when the diffraction intensity of the peak of the crystal phase A (peak near 2θ=29.58°) is designated as I_{A}, and the diffraction intensity of the peak of the crystal phase B (peak near 2θ=25.20°) is designated as I_{B}, the value of I_{B}/I_{A} is, for example, less than 0.37, and is preferably 0.1 or less. Also, the value of the ratio I_{B}/I_{A} is preferably 0.

Furthermore, as described in Comparative Example 3 below, if the proportion of LiX according to the present invention is too high, a crystal phase different from the crystal phase A and the crystal phase B is generated. When this crystal phase is designated as crystal phase C, the crystal phase C usually has a peak at 2θ=28.06°. Incidentally, there are occasions in which a position of this peak also approximates the given value in the range of ±1.00°. Among others, it is preferable that a position of each peak approximates the given value in the range of ±0.50°. The crystal phases A and C are both crystal phases exhibiting ion conductivity; however, there is a difference in the ion conductivity, and the crystal phase C is considered to have lower ion conductivity than the crystal phase A. Therefore, it is preferable that the sulfide solid electrolyte material of the present invention does not have the crystal phase C. Here, when the diffraction intensity of the peak of the crystal phase A (peak near 2θ=29.58°) is designated as I_{A}, and the diffraction intensity of the peak of the crystal phase C (peak near 2θ=28.06°) is designated as I_{C}, the value of I_{C}/I_{A} is, for example, less than 0.21, and is preferably less than 0.1. Also, the value of the ratio I_{C}/I_{A} is preferably 0.

Furthermore, as described in Patent Literature 1, there is a possibility that a crystal phase having lower ion conductivity than that of the crystal phase A may be precipitated at the time of precipitation of the crystal phase A. When this crystal phase is designated as crystal phase D, the crystal phase D usually has peaks at 20=17.46°, 18.12°, 19.99°, 22.73°, 25.72°, 27.33°, 29.16°, and 29.78°. Incidentally, there are occasions in which these peak positions also approximate the given values in the range of ±1.00°. Among others, it is preferable that a position of each peak approximates the given value in the range of ±0.50°.

The crystal phases A and D are both crystal phases that exhibit ion conductivity; however, there is a difference in the ion conductivity, and the crystal phase D is considered to have lower ion conductivity than the crystal phase A. Therefore, it is preferable that the proportion of the crystal phase D is smaller. Here, when the diffraction intensity of the peak of the crystal phase A (peak near 20=29.58°) is designated as I_{A}, and the diffraction intensity of the peak of the crystal phase D (peak near 20=27.33°) is designated as I_{D}, the value of I_{D}/I_{A} is, for example, less than 0.50, and the value of I_{D}/I_{A} is preferably 0.45 or less, more preferably 0.25 or less, even more preferably 0.15 or less, and particularly preferably 0.07 or less. Also, the value of the ratio I_{D}/I_{A} is preferably 0. In other words, it is preferable that the sulfide solid electrolyte material of the present invention does not have any peak near 2θ=27.33°.

Furthermore, the sulfide solid electrolyte material of the present invention comprises the Li element, Ge element, P element, S element, and X element (X is at least one of F, Cl, Br, and I). The sulfide solid electrolyte material of the present invention may comprise only the Li element, Ge element, P element, S element, and X element, or may further comprise other elements. The X element is preferably at least one of Cl, Br and I, and more preferably Br.

Furthermore, a composition of the sulfide solid electrolyte material of the present invention is usually represented by y(LiX) (100−y) (Li_{3.35}Ge_{0.35}P_{0.65}S₄). This composition corresponds to the case in which x=0.65 in the formula: y(LiX)·(100−y) (Li₍₄₋ₓ₎Ge₍₁₋ₓ₎PₓS₄). The composition of Li₍₄₋ₓ₎Ge₍₁₋ₓ₎PₓS₄ corresponds to the composition of a solid solution of Li₃PS₄ and Li₄GeS₄. That is, this composition corresponds to the composition on the tie-line of Li₃PS₄ and Li₄GeS₄. Li₃PS₄ and Li₄GeS₄ both correspond to the ortho-composition, and have an advantage of having high chemical stability.

Furthermore, “y” in the formula: y(LiX)·(100−y) (Li_{3.35}Ge_{0.35}P_{0.65}S₄) is set to a range by which higher ion conductivity than that of the sulfide solid electrolyte material with y=0 (Li_{3.35}Ge_{0.35}P_{0.65}S₄) is obtained. This “y” usually satisfies the relationship: 0<y, and it is preferable that the relationship: 1≦y is satisfied, while it is more preferable that the relationship: 3≦y is satisfied. On the other hand, “y” usually satisfies the relationship: y<20, and it is preferable that the relationship: y≦18 is satisfied, while it is more preferable that the relationship: y≦15 is satisfied. The value of “y” can be identified by, for example, calculating the molar ratio of X and P by ICP. Incidentally, the value of “x” can be identified by, for example, calculating the molar ratio of Ge and P by ICP.

The sulfide solid electrolyte material of the present invention is usually a sulfide solid electrolyte material having crystal property. Also, it is preferable that the sulfide solid electrolyte material of the present invention has high ion conductivity, and the ion conductivity of the sulfide solid electrolyte material at 25° C. is preferably 8×10⁻³ S/cm or more. Furthermore, the shape of the sulfide solid electrolyte material of the present invention is not particularly limited; however, for example, the sulfide solid electrolyte material may be in a powder form. In addition, the average particle size (D₅₀) of the powdered sulfide solid electrolyte material is preferably, for example, in the range of 0.1 μm to 50 μm.

Since the sulfide solid electrolyte material of the present invention has high ion conductivity, the sulfide solid electrolyte material can be used in any applications where ion conductivity is required. Among them, the sulfide solid electrolyte material of the present invention is preferably used in batteries. It is because the sulfide solid electrolyte material can contribute significantly to the increase of the output power of batteries. Furthermore, the method for producing the sulfide solid electrolyte material of the present invention will be described in detail in section “C. Method for producing sulfide solid electrolyte material” that will be described below.

B. Battery

Next, the battery of the present invention will be described. FIG. 2 is a schematic sectional view illustrating an example of the battery of the present invention. A battery 10 in FIG. 2 comprises a cathode active material layer 1 containing a cathode active material; an anode active material layer 2 containing an anode active material; an electrolyte layer 3 formed between the cathode active material layer 1 and the anode active material layer 2; a cathode current collector 4 that collects the current of the cathode active material layer 1; an anode current collector 5 that collects the current of the anode active material layer 2; and a battery case 6 for accommodating these members. A feature of the present invention is that at least one of the cathode active material layer 1, the anode active material layer 2, and the electrolyte layer 3 contains the sulfide solid electrolyte material described in the above section “A. Sulfide solid electrolyte material”.

According to the present invention, a battery with high output power can be obtained by using the sulfide solid electrolyte material described above.

Hereinafter, the constituent members of the battery of the present invention will be described.

1. Cathode Active Material Layer

The cathode active material layer according to the present invention is a layer containing at least a cathode active material, and may optionally contain at least one of a solid electrolyte material, a conductive material, and a binder material. Particularly, according to the present invention, it is preferable that the cathode active material layer contains a solid electrolyte material, and the solid electrolyte material is the sulfide solid electrolyte material described above. The proportion of the sulfide solid electrolyte material included in the cathode active material layer may vary depending on the kind of the battery; however, for example, the proportion is preferably in the range of 0.1 vol % to 80 vol %, more preferably in the range of 1 vol % to 60 vol %, and particularly preferably 10 vol % to 50 vol %. Furthermore, examples of the cathode active material include LiCoO₂, LiMnO₂, Li₂NiMn₃O₈, LiVO₂, LiCrO₂, LiFePO₄, LiCoPO₂, and LiNi_{1/3}Co_{1/3}Mn_{1/3}O₂.

The cathode active material layer may further contain a conductive material. Addition of the conductive material can bring about an increase in conductivity of the cathode active material layer. Examples of the conductive material include acetylene black, Ketjen black, and carbon fibers. Furthermore, the cathode active material layer may contain a binder material. Examples of the kind of the binder material include fluorine-containing binder materials such as polyvinylidene fluoride (PVDF). The thickness of the cathode active material layer is preferably, for example, in the range of 0.1 μm to 1000 μm.

2. Anode Active Material Layer

The anode active material layer according to the present invention is a layer containing at least an anode active material, and may optionally contain at least one of a solid electrolyte material, a conductive material, and a binder material. Particularly, according to the present invention, it is preferable that the anode active material layer contains a solid electrolyte material, and the solid electrolyte material is the sulfide solid electrolyte material described above. The proportion of the sulfide solid electrolyte material included in the anode active material layer may vary depending on the kind of the battery; however, the proportion is preferably, for example, in the range of 0.1 vol % to 80 vol %, more preferably in the range of 1 vol % to 60 vol %, and particularly preferably in the range of 10 vol % to 50 vol %. Furthermore, examples of the anode active material include a metal active material and a carbon active material. Examples of the metal active material include In, Al, Si, and Sn. On the other hand, examples of the carbon active material include mesocarbon microbeads (MCMB), highly ordered pyrolytic graphite (HOPG), hard carbon, and soft carbon.

Incidentally, in regard to the conductive material and the binder material used for the anode active material layer, the same matter as in the case of the cathode active material layer described above is applicable. Furthermore, the thickness of the anode active material layer is preferably, for example, in the range of 0.1 μm to 1000 μm.

3. Electrolyte Layer

The electrolyte layer according to the present invention is a layer formed between the cathode active material layer and the anode active material layer. The electrolyte layer is not particularly limited as long as it is a layer capable of ion conduction; however, it is preferable that the electrolyte layer is a solid electrolyte layer composed of a solid electrolyte material. It is because, compared with batteries that use liquid electrolytes, a highly safe battery can be obtained. Furthermore, according to the present invention, it is preferable that the solid electrolyte layer contains the sulfide solid electrolyte material described above. The proportion of the sulfide solid electrolyte material included in the solid electrolyte layer is preferably, for example, in the range of 10 vol % to 100 vol %, and more preferably in the range of 50 vol % to 100 vol %. The thickness of the solid electrolyte layer is preferably, for example, in the range of 0.1 μm to 1000 μm, and more preferably in the range of 0.1 μm to 300 μm. Furthermore, examples of the method for forming a solid electrolyte layer include a method of compression molding a solid electrolyte material.

Furthermore, the electrolyte layer according to the present invention may be a layer composed of a liquid electrolyte. In the case of using a liquid electrolyte, it is necessary to consider safety more cautiously compared with the case of using a solid electrolyte layer; however, high output power batteries can be obtained. In this case, at least one of the cathode active material layer and the anode active material layer usually contains the sulfide solid electrolyte material described above. A liquid electrolyte usually contains a lithium salt and an organic solvent (non-aqueous solvent). Examples of the lithium salt include inorganic lithium salts such as LiPF₆, LiBF₄, LiClO₄, and LiAsF₆; and organic lithium salts such as LiCF₃SO₃, LiN (CF₃SO₂)₂, LiN(C₂F₅SO₂)₂, and LiC(CF₃SO₂)₃. Examples of the organic solvent include ethylene carbonate (EC), propylene carbonate (PC), dimethyl carbonate (DMC), diethyl carbonate (DEC), ethyl methyl carbonate (EMC), and butylene carbonate (BC).

4. Other Configuration

The battery of the present invention comprises at least the cathode active material layer, electrolyte layer, and anode active material layer described above. Furthermore, the battery usually comprises a cathode current collector that collects the current of the cathode active material layer, and an anode current collector that collects the current of the anode active material layer. Examples of the material of the cathode current collector include SUS, aluminum, nickel, iron, titanium, and carbon. On the other hand, examples of the material of the anode current collector include SUS, copper, nickel, and carbon. Furthermore, it is preferable that the thickness, shape and the like of the cathode current collector and the anode current collector are appropriately selected in accordance with factors such as the use of the battery. Furthermore, regarding the battery case used in the present invention, a battery case for general batteries can be used. Examples of the battery case include a battery case made of SUS.

5. Battery

The battery of the present invention may be a primary battery, or may be a secondary battery; however, among others, it is preferable that the battery of the present invention is a secondary battery. It is because the battery can be repeatedly charged and discharged, and is useful as, for example, a battery for vehicles. Examples of the shape of the battery of the present invention include a coin type, a laminate type, a cylindrical type, and a box type. The method for producing the battery of the present invention is not particularly limited as long as it is a method capable of obtaining the battery described above, and a method similar to a general method for producing a battery can be used. For example, in a case in which the battery of the present invention is an all solid state battery, an example of the method for producing the battery is a method of sequentially pressing a material that constitutes the cathode active material layer, a material that constitutes the solid electrolyte layer, and a material that constitutes the anode active material layer, thereby producing a power generating element, accommodating this power generating element inside a battery case, and caulking the battery case.

C. Method for Producing Sulfide Solid Electrolyte Material

Next, the method for producing a sulfide solid electrolyte material of the present invention will be described. The method for producing a sulfide solid electrolyte material of the present invention is a method for producing the sulfide solid electrolyte material described above, and comprises steps of: an ion conductive material synthesis step of synthesizing an amorphized ion conductive material by mechanical milling using a raw material composition including the constituent component of the sulfide solid electrolyte material; and a heating step of heating the amorphized ion conductive material, and thereby obtaining the sulfide solid electrolyte material.

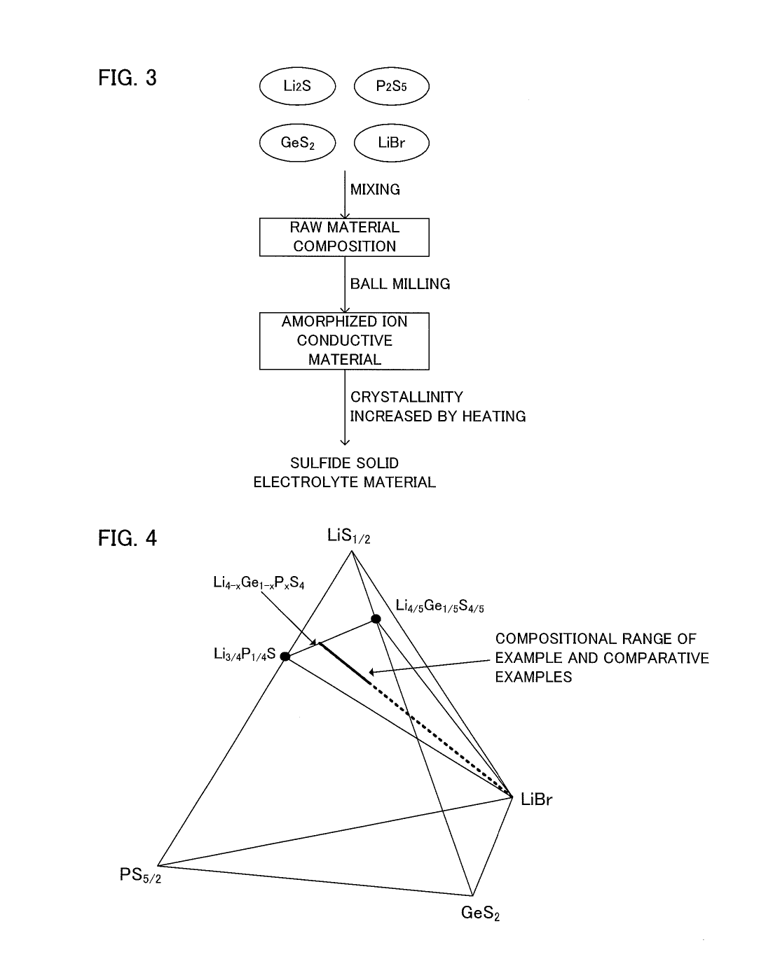

FIG. 3 is an explanatory view illustrating an example of the method for producing a sulfide solid electrolyte material of the present invention. In the method for producing a sulfide solid electrolyte material in FIG. 3, first, a raw material composition is produced by mixing Li₂S, P₂S₅, GeS₂ and LiBr. At this time, in order to prevent deterioration of the raw material composition by moisture in air, it is preferable to produce a raw material composition in an inert gas atmosphere. Next, the raw material composition is subjected to ball milling, and an amorphized ion conductive material is obtained. Next, the amorphized ion conductive material is heated, crystal property is increased, and thereby a sulfide solid electrolyte material is obtained.

According to the present invention, a sulfide solid electrolyte material having satisfactory ion conductivity can be obtained by performing amorphization in the ion conductive material synthesis step, and subsequently performing the heating step.

The respective steps of the method for producing a sulfide solid electrolyte material of the present invention are described below.

1. Ion Conductive Material Synthesis Step

The ion conductive material synthesis step according to the present invention is a step of synthesizing an amorphized ion conductive material by mechanical milling using a raw material composition including the constituent component of the sulfide solid electrolyte material.

The raw material composition according to the present invention contains at least the Li element, Ge element, P element, S element, and X element (X is at least one of F, Cl, Br, and I). Furthermore, the raw material composition may contain other elements described above. A compound that contains the Li element is, for example, sulfide of Li. Specific examples of the sulfide of Li include Li₂S.

Examples of the compound that contains the Ge element include simple Ge substance, and sulfide of Ge. Specific examples of the sulfide of Ge include GeS₂. Examples of the compound containing the P element include simple P substance, and sulfide of P. Specific examples of the sulfide of P include P₂S₅. Examples of the compound that contains the X element include LiX. Also, for the other elements that are used in the raw material composition, simple substances or sulfides can be used.

Mechanical milling is a method of pulverizing a sample while mechanical energy is applied. According to the present invention, an amorphized ion conductive material is synthesized by applying mechanical energy to the raw material composition. Examples of such mechanical milling include vibration milling, ball milling, turbo milling, Mechanofusion, and disc milling, and among them, vibration milling and ball milling are preferred.

The conditions for vibration milling are not particularly limited as long as an amorphized ion conductive material can be obtained. The amplitude of vibration for the vibration milling is preferably, for example, in the range of 5 mm to 15 mm, and more preferably in the range of 6 mm to 10 mm. The vibration frequency for the vibration milling is preferably, for example, in the range of 500 rpm to 2000 rpm, and more preferably in the range of 1000 rpm to 1800 rpm. The packing ratio of the sample for the vibration milling is preferably, for example, in the range of 1 vol % to 80 vol %, more preferably in the range of 5 vol % to 60 vol %, and particularly preferably in the range of 10 vol % to 50 vol %. Furthermore, it is preferable to use a vibrator (for example, a vibrator made of aluminum) for the vibration milling.

The conditions for ball milling are not particularly limited as long as an amorphized ion conductive material can be obtained. In general, as the speed of rotation increases, the rate of production of the ion conductive material is increased, and as the treatment time is longer, the conversion ratio from the raw material composition to the ion conductive material is increased. The speed of table rotation at the time of performing planetary ball milling is preferably, for example, in the range of 200 rpm to 500 rpm, and more preferably in the range of 250 rpm to 400 rpm. Furthermore, the treatment time at the time of performing planetary ball milling is preferably, for example, in the range of 1 hour to 100 hours, and more preferably in the range of 1 hour to 70 hours.

2. Heating step The heating step according to the present invention is a step of obtaining the sulfide solid electrolyte material described above by heating the amorphized ion conductive material.

The heating temperature according to the present invention is not particularly limited as long as it is a temperature at which the desired sulfide solid electrolyte material can be obtained; however, for example, the heating temperature is preferably 300° C. higher, more preferably 350° C. higher, and even more preferably 400° C. or higher. On the other hand, the heating temperature is preferably, for example, 1000° C. or lower, more preferably 700° C. or lower, even more preferably 650° C. or lower, and particularly preferably 600° C. or lower. Furthermore, it is preferable that the heating time is appropriately adjusted so as to obtain the desired sulfide solid electrolyte material. Also, it is preferable that the heating according to the present invention is carried out in an inert gas atmosphere or in a vacuum from the viewpoint of preventing oxidation. Furthermore, regarding the sulfide solid electrolyte material obtainable by the present invention, the same matter as that described in the above section “A. Sulfide solid electrolyte material” is applicable, and further description will not be repeated here.

Incidentally, the present invention is not intended to be limited to the embodiment described above. The embodiment described above is given only for illustrative purposes, and any embodiment having substantially the same configuration as the technical idea described in the claims of the present invention and provides similar operating effects, is construed to be included in the technical scope of the present invention.

### EXAMPLES

Hereinafter, the present invention will be described more specifically by way of Examples.

### Example 1

Lithium sulfide (Li₂S, manufactured by Nippon Chemical Industrial Co., Ltd.), diphosphorus pentasulfide (P₂S₅, manufactured by Sigma-Aldrich Co., Inc.), germanium sulfide (GeS₂, manufactured by Kojundo Chemical Laboratory Co., Ltd.), and lithium bromide (LiBr, manufactured by Kojundo Chemical Laboratory Co., Ltd.) were used as starting raw materials. The powders of these substances were mixed at the weight proportions indicated in the following Table 1 in a glove box in an argon atmosphere, and thus a raw material composition was obtained. Next, 1 g of the raw material composition was introduced into a pot (45 ml) made of zirconia together with zirconia balls (10 mmφ), 10 balls), and the pot was completely sealed (argon atmosphere). This pot was mounted on a planetary ball milling machine (P7™ manufactured by Fritsch Japan Co., Ltd.), and mechanical milling was carried out for 40 hours at a speed of table rotation of 370 rpm. Thereby, an amorphized ion conductive material was obtained.

Next, a powder of the ion conductive material thus obtained was introduced into a carbon-coated quartz tube, and the tube was vacuum-sealed. The pressure of the vacuum-sealed quartz tube was about 30 Pa. Subsequently, the quartz tube was installed in a calcining furnace, and the temperature was increased from room temperature to 400° C. over 6 hours, maintained at 400° C. for 8 hours, and then slowly decreased to room temperature. Thereby, a sulfide solid electrolyte material having a composition of 0.11 (LiBr).(Li_{3.35}Ge_{0.35}P_{0.65}S₄) was obtained. Incidentally, the composition corresponds to a composition of y(LiBr)·(100−y)(Li₍₄₋ₓ₎Ge₍₁₋ₓ₎PₓS₄) with x=0.65 and y=10.

### Comparative Examples 1 to 3

Sulfide solid electrolyte materials were obtained in the same manner as in Example 1, except that the proportions of the raw material compositions were changed to the proportions indicated in the following Table 1. Incidentally, FIG. 4 is a quaternary phase view showing the compositional range of the sulfide solid electrolyte materials obtained in Example 1 and Comparative Examples 1 to 3.

TABLE 1

| | | Comparative | Comparative | Comparative |
|---|---|---|---|---|
| | Example 1 | Example 1 | Example 2 | Example 3 |
| x | 0.65 | 0.65 | 0.65 | 0.65 |
| y | 10 | 0 | 20 | 30 |
| Li₂S | 0.372299 | 0.390529 | 0.351774 | 0.328489 |
| P₂S₅ | 0.349453 | 0.366564 | 0.330187 | 0.308332 |
| GeS₂ | 0.231568 | 0.242907 | 0.218801 | 0.204319 |
| LiBr | 0.046679 | 0 | 0.099238 | 0.158861 |

[Evaluation]

(X-Ray Diffractometry)

X-ray diffractometry (XRD) was carried out using the sulfide solid electrolyte materials obtained in Example 1 and Comparative Examples 1 to 3. The XRD analysis was carried out for powdered samples under the conditions of using CuKα ray in an inert atmosphere. The results are presented in FIG. 5. As illustrated in FIG. 5, the crystal phase A was precipitated in all of Example 1 and Comparative Examples 1 to 3. Particularly, in Example 1 and Comparative Example 1, the crystal phase A was obtained as a single phase, and the peak of the crystal phase B at 2θ=25.20° did not appear. On the other hand, in Comparative Example 2, the peak of the crystal phase B appeared at 2θ=25.20°. Furthermore, in Comparative Example 3, a small peak of the crystal phase B appeared at 2θ=25.20°, and the peak of the crystal phase C appeared at 2θ=28.06°. The diffraction intensity of the peak of the crystal phase A (peak near 20=29.58°) was designated. as I_{A}; the diffraction intensity of the peak of the crystal phase B (peak near 2θ=25.20°) was designated as I_{B}; the diffraction intensity of the peak of the crystal phase C (peak near 2θ=28.06°) was designated as I_{C}, and the ratios I_{B}/I_{A} and I_{C}/I_{A} were determined. Incidentally, in all of the sulfide solid electrolyte materials, the crystal phase D did not precipitate.

(Measurement of Li Ion Conductance)

The Li ion conductance at 25° C. was measured using the sulfide solid electrolyte materials obtained in Example 1 and Comparative Examples 1 to 3. First, 200 mg of a sulfide solid electrolyte material was weighed and introduced into a cylinder made of Macor, and the sample was pressed at a pressure of 4 ton/cm². The two ends of a pellet thus obtained were placed between pins made of SUS, and a restraining pressure was applied to the pellet by bolting. Thus, a cell for evaluation was obtained. While the cell for evaluation was maintained at 25° C., the Li ion conductance was calculated by an alternating impedance method. A SOLARTRON 1260™ was used for the measurement, and the applied voltage was 5 mV, while the measurement frequency range was set at 0.01 MHz to 1 MHz. The results are presented in FIG. 6 and Table 2.

TABLE 2

| | | | | | | Li ion |
|---|---|---|---|---|---|---|
| | Composition | x | y | I_{B}/I_{A} | I_{C}/I_{A} | conductance (S/cm) |
| Comparative | Li_{3.35}Ge_{0.35}P_{0.65}S₄ | 0.65 | 0 | 0 | 0 | 7.91 × 10⁻³ |
| Example 1 | | | | | | |
| Example 1 | 0.11LiBr•Li_{3.35}Ge_{0.35}P_{0.65}S₄ | 0.65 | 10 | 0 | 0 | 8.97 × 10⁻³ |
| Comparative | 0.25LiBr•Li_{3.35}Ge_{0.35}P_{0.65}S₄ | 0.65 | 20 | 0.37 | 0 | 7.72 × 10⁻³ |
| Example 2 | | | | | | |
| Comparative | 0.43LiBr•Li_{3.35}Ge_{0.35}P_{0.65}S₄ | 0.65 | 30 | 0.10 | 0.21 | 7.11 × 10⁻³ |
| Example 3 | | | | | | |

As illustrated in FIG. 6 and Table 2, it was confirmed that Example 1 exhibited a higher Li ion conductance than Comparative Examples 1 to 3. Particularly, in both Example 1 and Comparative Example 1, the crystal phase A could be obtained as a single phase; however, ion conductivity was increased by the addition of the X element. On the other hand, in Comparative Example 2, the peak of the crystal phase B appeared near 2θ=25.20°. Since the ion conductivity of the crystal phase B was lower than the ion conductivity of the crystal phase A, it is speculated that the Li ion conductance was lower in Comparative Example 2 than in Example 1. From the above results, it was confirmed that an increase in ion conductivity can be promoted by adding the X element to the extent that no peak of the crystal phase B appears.

### REFERENCE SIGNS LIST

1 cathode active material layer
2 anode active material layer
3 electrolyte layer
4 cathode current collector
5 anode current collector
6 battery case
10 battery

What is claimed is:

1. A sulfide solid electrolyte material comprising a Li element, a Ge element, a P element, a S element, and an X element (X is at least one of F, Cl, Br, and I),
wherein the sulfide solid electrolyte material comprising a crystal phase A having a peak at a position of 2θ=29.58°±1.00° measured by X-ray diffractometry using CuKα ray,
having a composition of y(LiX)·(100−y) (Li_{3.35}Ge_{0.35}P_{0.65}S₄) (y satisfies the relationship: 0<y<20), and
the sulfide solid electrolyte material does not comprise a crystal phase B having a peak at a position of 2θ=25.20°±1.00° measured by X-ray diffractometry using CuKα ray.

2. The sulfide solid electrolyte material according to claim 1, wherein X is Br.

3. A battery comprising:
a cathode active material layer containing a cathode active material;
an anode active material layer containing an anode active material; and
an electrolyte layer formed between the cathode active material layer and the anode active material layer,
wherein at least one of the cathode active material layer, the anode active material layer and the electrolyte layer contains the sulfide solid electrolyte material according to claim 1.

4. A method for producing a sulfide solid electrolyte material, the sulfide solid electrolyte material being the sulfide solid electrolyte material according to claim 1, the method comprising steps of:
an ion conductive material synthesis step of synthesizing an amorphized ion conductive material by mechanical milling using a raw material composition containing a constituent component of the sulfide solid electrolyte material; and
a heating step of heating the amorphized ion conductive material, and thereby obtaining the sulfide solid electrolyte material.
